(19) United States
(12) Patent Application Publication
(10) Pub. No.: US 2026/0300940 A1
(43) Pub. Date: Oct. 1, 2026

(54) METHODS AND SYSTEMS TO MODERATE CONTENT CONSUMPTION

(71) Applicant: Adeia Guides Inc., San Jose, CA (US)

(72) Inventor: Jean-Yves Couleaud, Mission Viejo, CA (US)

(21) Appl. No.: 19/096,031

(22) Filed: Mar. 31, 2025

(51) Int. Cl. G06Q 50/00; G06F 3/0485; G06F 40/30

(52) U.S. Cl. CPC G06Q 10/40; G06F 40/30; G06F 3/0485

(57) ABSTRACT

Systems and methods are described for moderating content consumption. Content items are generated for sequential display, A moderation score is determined for each content item in a set of sequentially displayed content items. The moderation score for each content item in the set is based on a signification of the content item. A cumulative moderation score for the set of sequentially displayed content items is determined to be greater than a threshold moderation score. An action affecting the continued consumption of the sequentially displayed content items is caused.

### BACKGROUND

The present disclosure relates to methods and systems configured to moderate content consumption, e.g., across devices and platforms. Particularly, but not exclusively, the present disclosure relates to an operating system of a user device or a third-party service associated with a user device classifying displayed content items based on their signification (e.g., visual/semantic meaning), and computing a cumulative moderation score based on repetition in the display of certain classes of content items versus other classes of content items. The present disclosure also relates to detecting that the cumulative moderation score exceeds a threshold, and taking action to affect how further content is consumed.

### SUMMARY

With the prevalence of social media and over-the-top (OOT) content delivery there is an ever-increasing amount of content available for consumption by a user. For example, a search or an interaction with content on a social media or content delivery platform may lead to users being recommended content of a similar or repetitive type, e.g., based on a user preference or current events and trends. This may lead to the user being confined to consuming content with a similar trend or meaning with limited exploration into other types of content. More specifically, the term “doomscrolling” captures how users are led down a path spending an excessive amount of time consuming large quantities of content, usually of the same type and sometimes with overall negative connotations or sentiment.

In some approaches, there are features in place to reduce a user's exposure to content delivered by a media platform, such as setting a daily time limit for which a user may consume content from the platform. However, this approach pays no regard to the type of content being consumed. Should a media platform implement content moderation based on an amount of content of a particular type being consumed by a user, it may do so by accessing data under its control that is indicative of the type of content being consumed by a user. As such, it becomes difficult for a party and/or system external to the media platform to moderate the content delivered by the media platform, e.g., without direct access to content data. This problem is compounded when trying to moderate content consumption across multiple media platforms, as each media platform may have to implement, separately, content tracking and moderation, which lacks efficiency and coordination. In general, it is desirable to minimize the repetition of content delivery to reduce resource usage by media platforms, which can lead to improved user engagement and allow users to consume content in a healthy and explorative manner, and with overall content delivery efficiency.

Systems and methods are provided herein for improving the moderation of content consumption, e.g., by taking action (e.g., causing processing of control circuitry) in response to a repetition of a class of content items that appears on one or more media platforms at a user device or across user devices. For example, content items may be classified based on their signification (e.g., a derived objective meaning) and given a moderation score independently from a media platform that delivers the content. For example, a third-party moderation service and/or an operating system associated with the user device may implement content tracking for the purpose of content moderation. In some cases, the moderation score may be determined for individual content items or pieces of media presented on a display of the user device, e.g., as a user scrolls through content, based on visual and/or semantic differences between the presented media.

In some cases, the third-party moderation service and/or operating system may determine and monitor a cumulative moderation score and compare the cumulative moderation score to a threshold score. When the threshold score is exceeded, the third-party moderation service and/or the operating system may trigger an action to occur that affects how further content is consumed across one or multiple media platforms. For example, the user may be consuming a repetition of a class of content items, e.g., political news, on one or multiple media platforms which may cause the cumulative moderation score to exceed the threshold score. The threshold score being exceeded may trigger one or more media applications to alter the consumption of upcoming content items to reduce the repetition of content, or at least the repetition of content having a similar signification.

According to the systems and methods described herein, content items, e.g., videos, photos, audio files, social media posts, advertisements, are generated for sequential display. For example, a user device or devices may receive content items for sequential display, wherein the content items are distributed from one or more content providers. A moderation score for each content item in a set of sequentially displayed content items is determined, e.g., using control circuitry associated with the user device(s) and/or dissociated from the one or more content providers. In some cases, the control circuitry associated with the user device(s) may be an operating system of the user device(s). Additionally or alternatively, the control circuitry associated with the user device(s) may be supported by a third-party, separate from the one or more content providers and/or from a provider of the operating system of the user device(s).

The moderation score for each content item in the set is based on a signification of the content item. For example, the moderation score may be determined based on a sentiment and/or an impression derived by the user from the content item. A cumulative moderation score is compared to a threshold moderation score. An action affecting the continued consumption of the sequentially displayed content items is caused in response to the cumulative moderation score being greater than the threshold moderation score, e.g., a notification is generated to alert a user that the cumulative moderation score has exceeded the threshold score. In some cases, there may be an issue of moderating content across different devices and between different platforms, e.g., an operating system or a third party may lack relevant information about the displayed content to perform the moderation effectively. The systems and methods disclosed herein provide a solution to these issues by configuring a system at the operating system-level and/or via a third-party application to analyze and accumulate data usable to perform the content moderation effectively, e.g., independently from a content provider or access to a content provider's data.

In some examples, the signification of a content item may be determined using textual metadata, e.g., a caption accompanying a social media post, a visual characteristic of the content item, e.g., an image embedded with a news story, and/or a sentiment analysis, e.g., using a Large Language Model (LLM) or a machine learning model trained on responses of other users to the content item.

In some examples, parameters that weight the moderation score may be determined. A parameter may be a display period determined for each content item in the set of sequentially displayed content items, e.g., a period for which a content item is displayed on a user device. A parameter may be a focus value for each content item, e.g., a gaze direction of a user relative to a displayed content item may cause the moderation score of the content item to be adjusted. A parameter may be a sentiment score determined based on the sentiment analysis, e.g., a score ranging from −1 to 1, wherein −1 may represent a content item with a positive message (e.g., to lower the cumulative moderation score) and +1 may represent a content item with a negative message (e.g., to raise the cumulative moderation score).

In some examples, a decay factor may be determined for each content item. The decay factor may be based on a display order of each content item in the set of the sequentially displayed content items, e.g., the moderation score of a past content item may decrease when the user continues to scroll through new content items. The decay factor may be based on a duration for which each content item in a set of the sequentially displayed content items is no longer displayed after being displayed, e.g., a period between a time at which a content item was first viewed by the user in comparison to a current display state (e.g., displaying subsequent content items).

In some examples, sequentially displayed content items may be generated for display using a scrolling operation, e.g., a scrolling input received at the user device. The user device may detect the scrolling operation, e.g., a user swiping on a touchscreen of a mobile phone, and generate the sequentially displayed content items. A segmentation operation may be performed on the sequentially displayed content items to define the set of sequentially displayed media content items in response to the detected scrolling operation. In some examples, the segmentation operation may comprise segmenting the sequentially displayed media content items based on visual and/or semantic differences using computer vision including optical character recognition, to determine individual elements of media content. In some examples, the segmentation operation may occur independently from, e.g., without influence from, a provider or providers of the sequentially displayed media content items.

In some examples, the sequentially displayed content items may be distributed for display from multiple content providers, e.g., content items from two or more different content providers. In some examples, the sequentially displayed content items may be distributed for display across multiple user devices, e.g., a first device, such as a TV, and a second device, such as a smartphone. In some examples, the distribution of content across multiple user devices is managed by virtue of a user profile.

In some examples, a moderation score for a content item may be determined using a user reaction to the content item. A user reaction may be determined, e.g., based on feedback received from the user relating to the content.

In some examples, upcoming content items may not be displayed, may be delayed, or otherwise selectively included due to the cumulative moderation score of the upcoming content items (e.g., in combination with a currently displayed and/or one or more previously displayed content items) being greater than the threshold score. Metadata associated with the upcoming content items may be received at the user device. A moderation score associated with the upcoming content items may be determined. If the cumulative moderation score associated with the upcoming content items is greater than the threshold score, the upcoming content items may not be displayed, or otherwise displayed in a modified state.

In some examples, a moderation score may be updated based on a number of instances, e.g., multiple instances, that a first content item (or a substantially similar content item) is displayed. The moderation score may be updated based on the number of instances that the first content item in the set of sequentially displayed content items is displayed.

In some examples, the moderation score may be determined using a user device, an XR device and/or a third-party service operating in cooperation with a content provider distributing content to a user device on which the content items are generated for display. The moderation score may be determined using each system alone or in combination with one another.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates an overview of moderating content consumption on a user device, in accordance with some examples of the disclosure;

FIG. 2 illustrates an overview of a system for moderating content consumption using multiple devices, in accordance with some examples of the disclosure;

FIG. 3 is a flowchart representing a process for moderating content consumption, in accordance with some examples of the disclosure;

FIG. 4 is a flowchart representing a process for moderating content consumption, in accordance with some examples of the disclosure;

FIG. 5 illustrates example media content having a moderation score, in accordance with some examples of the disclosure;

FIG. 6 illustrates example media content having a moderation score, in accordance with some examples of the disclosure;

FIG. 7 illustrates an overview of an example system for moderating content consumption across different content providers, in accordance with some examples of the disclosure;

FIG. 8 illustrates a block diagram of a system for moderating content consumption, in accordance with some examples of the disclosure;

FIG. 9 illustrates an overview of an example sequence for moderating content consumption across multiple media platforms, in accordance with some examples of the disclosure; and

FIG. 10 illustrates a block diagram of a system for moderating content consumption, in accordance with some examples of the disclosure.

### DETAILED DESCRIPTION

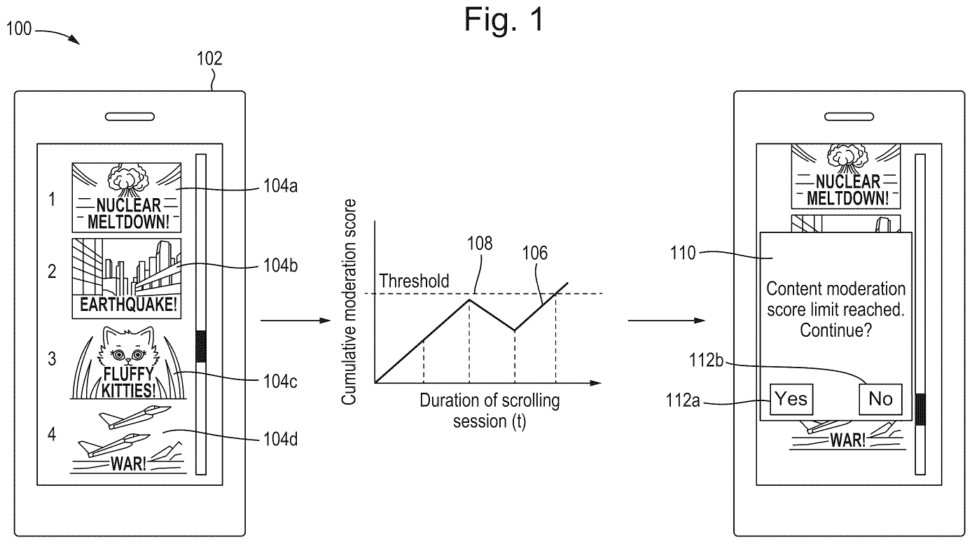

FIG. 1 illustrates an overview of a system 100 for moderating content consumption, e.g., on or at a user device 102. In particular, the example shown in FIG. 1 illustrates a user device 102 displaying a sequence of content items, e.g., that are on a scrollable social media feed. However, the content items may be generated for display in any appropriate manner, e.g., from one or more content providers, and optionally across multiple user devices at various time. In other words, the present disclosure is not limited to the sequential display of content in a single session and anticipates that the consumption of media content may occur along a continuous or a fragmented timeline, using one or more content delivery platforms and/or user devices. For example, a sequence of displayed (or buffered) content items may be in an order with or without interruptions. For example, an interruption between content items may comprise titles, credits, ads and/or any other appropriate supplemental content. In some examples, the sequence of displayed (or buffered) content items may be browsable content, scrollable content, and/or autoplay content, accessible across one or more platforms and/or devices. Additionally or alternatively, the sequence of content items may comprise a set of various content items displayed within time limits, e.g., a day or week. In this manner, the user device may display content items, in a sequential order, a consecutive order, a serial order (e.g., with episode number), or in any other arranged manner, e.g., by way of trend or content type.

In the example shown in FIG. 1, system 100 comprises control circuitry, e.g., of user device 102 and/or a third-party application performing on a media platform. The system 100 is configured to determine a moderation score for one or more of the sequentially displayed content items (104a, 104b, 104c, 104d) based on their signification. For example, control circuitry associated with the user device, such as an operating system of the user device, may determine the moderation score for one or more of the sequentially displayed content items (104a, 104b, 104c, 104d). Working separately or in coordination, the third-party application may determine the moderation score for one or more of the sequentially displayed content items (104a, 104b, 104c, 104d). In some cases, the control circuitry associated with the user device comprises the third-party application running on the user device or otherwise accessible by the user device, e.g., via network communication. In the context of the present disclosure, the term “signification” is understood to mean a determined meaning, based on one or more objective and/or subjective parameters. For example, the moderation score for each content item may be based on visual and/or semantic signification, a signification derived from a duration for which a content item appears on the user device, a signification derived from a legibility of the content item and/or may be based on a signification derived from a user reaction to the content item, e.g., based on gaze or other input data. In the example shown in FIG. 0.1, each of content items 104a-d relate to an event or story. For example, content item 104a is a content item sensationalizing a fictional “nuclear meltdown” event, content item 104b relates to a news article about an “earthquake”, content item 104c relates to “fluffy kitties”, and content item 104d shows a new story about “war”. To determine a signification for each of the content items 104a-104d, their content is analyzed based on data describing their content, e.g., one or more of textual metadata associated with the content item, a visual characteristic of the content item, sentiment analysis of the content item and/or category data associated with the content item (discussed below in more detail). Based on the determined signification, each content item is assigned a moderation score or value, e.g., an absolute or relative score. In the example shown in FIG. 1, the moderation score is a score between +1 and −1. For example, content item 104a scores+1, content item 104b scores+1, content item 104c scores −1 and content item 104d scores+1, as a scrolling session progresses on device 102. The sum of the moderation scores for each content item is equal to (or is at least a factor in determining) the cumulative moderation score 106.

In the example shown in FIG. 1, control circuitry is configured to compare the cumulative moderation score 106 to a threshold score 108. When the cumulative moderation score reaches or exceeds the threshold score 108, an action is taken to stop (or at least attempt to limit) the cumulative score from getting higher. For example, the threshold score 108 may be set by a user, e.g., a parent moderating the content for a child user (e.g., for safety reasons), or a content provider attempting to moderate the content delivered to a client device (e.g., to help avoid the expenditure of resources in providing duplicated content). In the example shown in FIG. 1, control circuitry of system 100 generates a notification 110 on the user device 102 in response to the cumulative moderation score 106 exceeding the threshold 108. By virtue of generating the notification 110, a user is given an option to continue consuming subsequent content items 112a or to stop 112b. For example, if the user selects “No” 112b, an alteration to the upcoming content may be caused or a content provider's application may be shut down or restricted for a period. Other alternative or additional actions are described below in more detail. In some cases, the notification 110 may be a sound alert, a vibration of the user device, or an automatic altering of subsequent content items (e.g., yet to be displayed content items from a buffer) causing an increase in the cumulative moderation score.

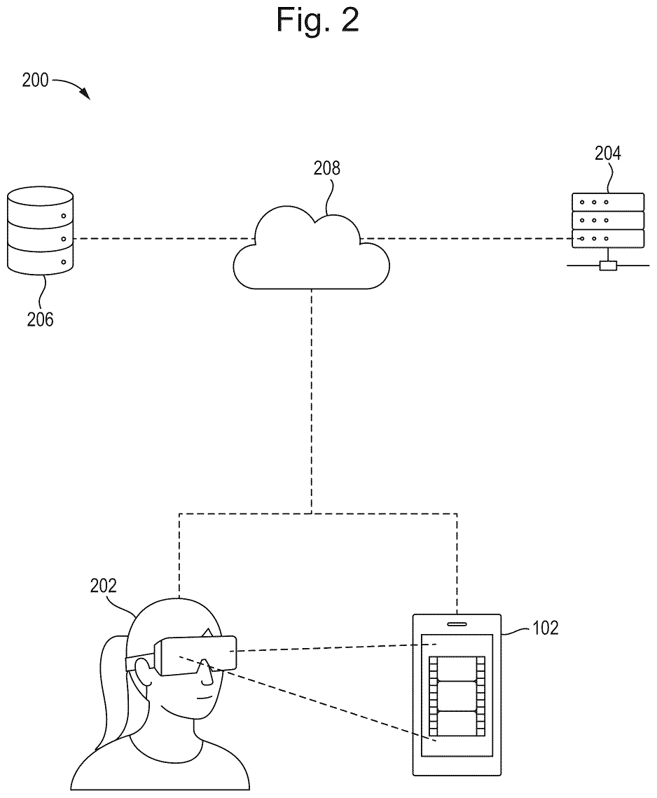

In the example shown in FIG. 2, content items can be displayed on one or more user devices 102, 202. For example, an XR device 202, e.g. an XR headset, may be viewing the user device 102 on which the content items 104a-d are generated for display. Additionally or alternatively, there may be a third-party service operating in cooperation with a content provider to distribute the content items to the user device 102, 202. The third-party services may be executed on server 204 and be in communication with the network 208 (the cloud) to deliver content items to the user device 102, 202.

More specifically, FIG. 2 illustrates an overview of a system 200 for generating content items for one or more user devices 202. In particular, the example shown in FIG. 2 illustrates a user having an XR device 202, such as a head-mounted display (HMD), communicatively coupled to a server 204 and a content database 206, e.g., via a network 208. In this manner, the XR device 202 provides the user with access to an XR environment and/or service provided by a sever 204. For example, the XR environment may be a virtual reality (VR), augmented reality (AR) or mixed reality (MR) environment accessible to the user when operating an XR device 202. When the user is in or accessing the XR environment, the user can interact with one or more user devices, e.g., 102, communicatively coupled to server 204 and content item database 206, e.g., via network 208. For example, the user may interact with one or more user devices, e.g., a display screen of user device 102. In particular, the XR environment may be an AR environment or an MR environment provided or facilitated by XR device 202, which allows the user to physically see user device 102 and the content items for sequential display on the user device 102. In other examples, the XR environment may be a VR environment provided by XR device 202, which provides a virtual arena or environment which allows the user to see a virtual representation of user device 102. In some instances, the XR device 202 may provide such a virtual representation of a device or a virtual device that has no physical counterpart. Each user device 102 may be a physical electronic device or a virtual device. For example, physical devices include mobile phones, and tablets. A virtual device may be a software-driven representation or proxy of a physical device (e.g., an emulation instantiated by an emulator). In some instances, a virtual device may be a virtual twin of a physical user device 102. The XR device 202 and user device 102 may be used either alone or in combination, e.g., the XR device 202 may be used to monitor sequentially displayed content on the user device 102. In some examples, the XR device 202 may monitor content consumed throughout user interactions with multiple devices, e.g., a user may consume content on a mobile phone, tablet, a TV and/or an advertising display whilst wearing the XR device 202.

In some examples, the user device 102 comprises control circuitry configured to execute a media platform and provide, at a display screen of the user device 102, a user interface to control the media platform, and thus the XR device 202. In some examples, server 204 may comprise control circuitry configured to execute a media platform and cooperate with user device 102 to provide, at a display screen of the user device 102, a remote user interface to control the media platform, and thus the user device 202. For example, a user may set content moderation preferences on the media platform at the user device 102 to moderate content on the user device 202. In response to the user device 102 setting content preferences in the application, the XR device 202 may moderate content that the user device 102 consumes based on the content preferences that have been set. In other examples, the user device 102 may set different content moderation preferences for multiple devices in the application. In response, the XR device 202 may moderate content across multiple devices with different content moderation preferences. Irrespective of the location at which the media platform is executed for controlling the user device 202, the user device 102 may be operationally coupled with XR device 202 to provide content moderation across multiple devices.

In the example shown in FIG. 2, the XR device is depicted as head-mounted display 202. However, the XR device may be any appropriate type of device, such as a tablet computer, a smartphone, smart contact lens, or the like, used either alone or in combination, configured to display or otherwise provide access to an XR environment.

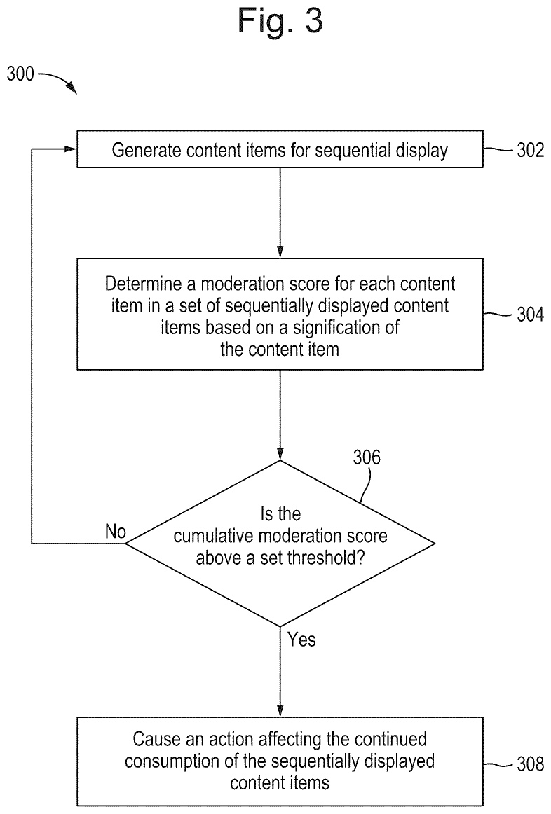

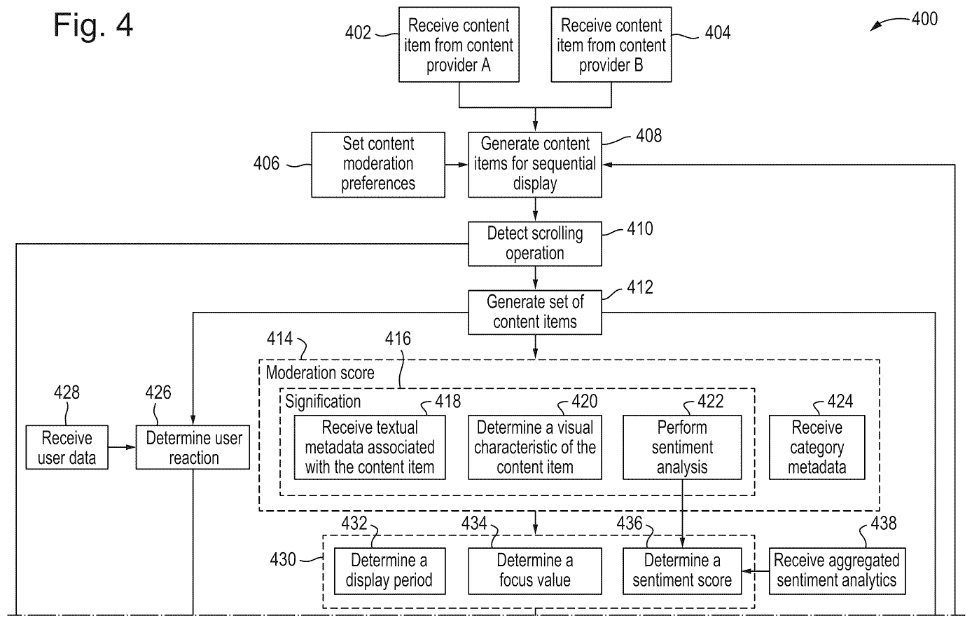

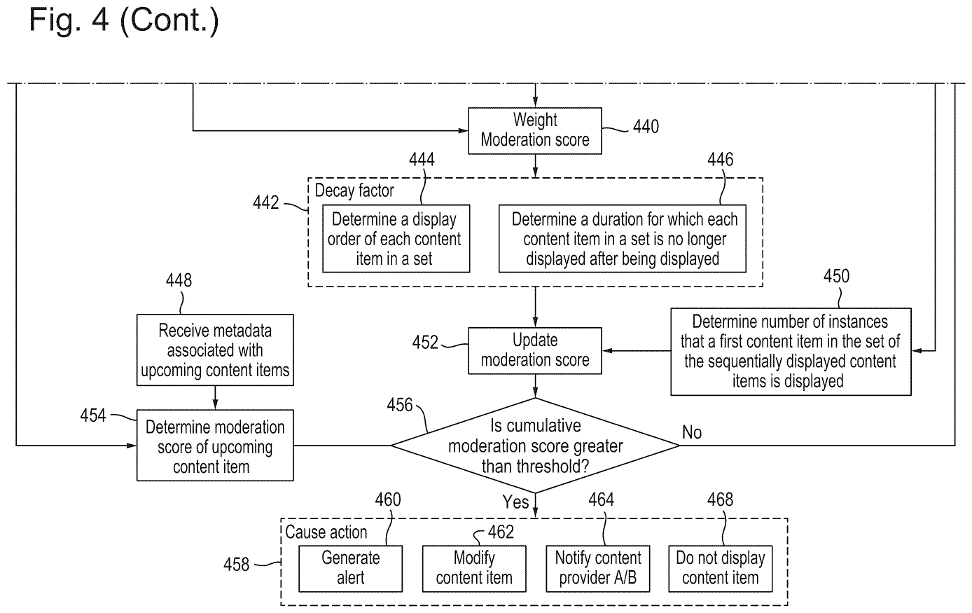

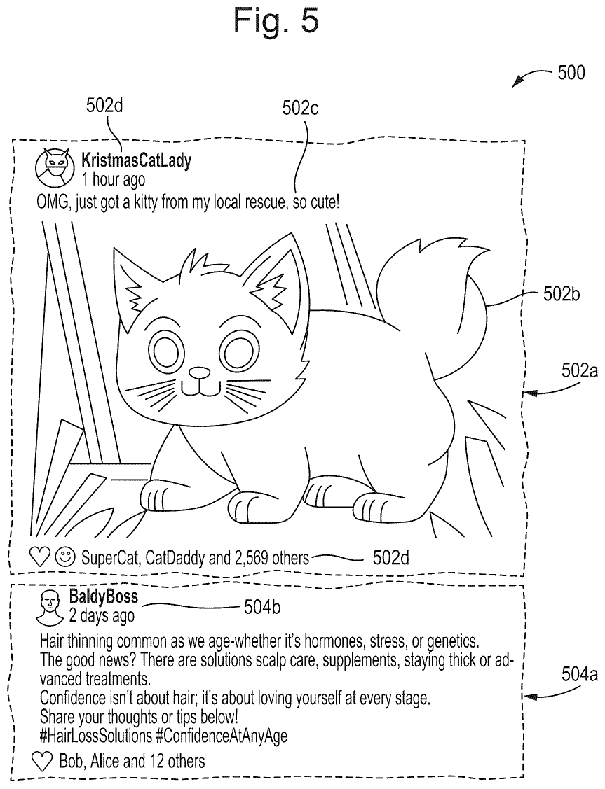

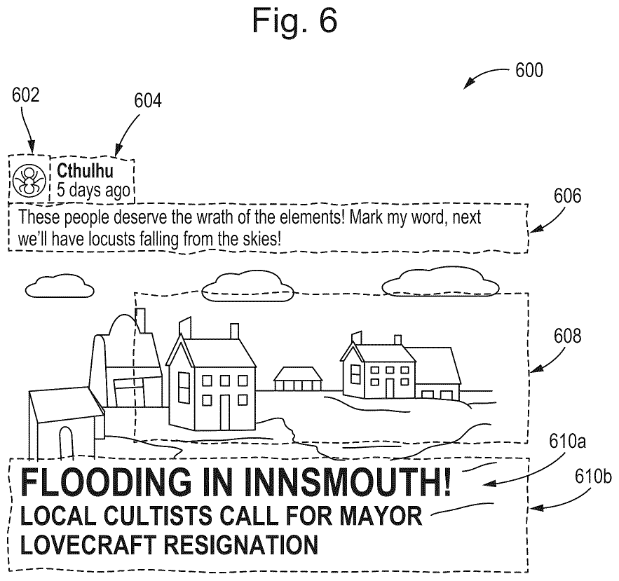

FIG. 3 shows a flowchart representing an illustrative process 300 for moderating content consumption, e.g., on user device 102 and/or 202, such as the content items shown in FIG. 1. FIG. 4 illustrates a flowchart representing the moderation of content consumption across multiple content providers. FIG. 5 illustrates the segmentation of content items and scrollable operations. FIG. 6 illustrates the determination of the signification of a content item. While the examples shown in FIGS. 3 to 6 refer to the use of system 100, as shown in FIG. 1, it will be appreciated that the illustrative process 300 shown in FIG. 3, with reference to FIGS. 4 to 6, may be implemented, in whole or in part, on system 100, system 200, and/or any other appropriately configured system architecture. For the avoidance of doubt, the term “control circuitry” used in the below description applies broadly to the control circuitry outlined above with reference to FIG. 2. For example, control circuitry may comprise control circuitry of user device 102, control circuitry of the XR device 202 and control circuitry of a server 204, working either alone or in some combination.

At 302, control circuitry, e.g., control circuitry 1018 of the user device 102 and/or 202, generates content items for sequential display on the user device 102 and/or 202. For example, the control circuitry of user device 102 and/or 202, may communicate with a server 204, via a network 208, to generate content items for sequential display, e.g., a news feed on a virtual user device 102 being viewed by an XR headset 202. In some examples, content items may be simultaneously generated on an XR headset 202 and a virtual user device 102, e.g., a new article may be in one portion of the user's peripheral vision and a video being displayed on a virtual user device 102 may be in another portion of the user's peripheral vision.

At 304, control circuitry determines a moderation score for each content item in a set of sequentially displayed content items. In the context of the present disclosure, a “set of sequentially displayed content items” refers to one or more content items that have or will be generated for display. For the avoidance of doubt, the “set of sequentially displayed content items” need not include every content generated for display. At 304, control circuitry of the user device and/or the content operating server 204 may access visual and textual metadata, and the category of a content item and score the content item, e.g., “nuclear meltdown” may result in a moderation score of +1. In some examples, as discussed below, the score may be dependent on a sentiment analysis, e.g., in addition to an objective analysis of the content of the content item. In this manner, the moderation scores for each content item in a set can be totaled to formulate a cumulative moderation score 106.

At 306, the cumulative moderation score 106 is compared to a threshold score 108. When the cumulative moderation score 106 is less than the threshold moderation score 108, process 300 moves to 302. When the cumulative moderation score 106 is greater than the threshold moderation score 108, process 300 moves to 308.

In some examples, the threshold score 108 may be set by the user and/or a content provider. The threshold score is compared to the cumulative moderation score, and actions are caused as a result of the threshold score being exceeded. For example, control circuitry may execute a command to set a “high” threshold score which triggers an action at 308, e.g., control circuitry of the user device 102 may generate for display a notification 110 to the user device 102 indicating that the threshold has been exceeded. In some examples, the notification 110 may be accompanied by a vibration of the user device 102 and/or a sound alert, e.g., an alarm may sound through speakers of the user device 102. In some examples, the XR device 202 may be used in combination with user device 102 and a notification 110 may be presented at the XR device 202 which blocks the view of the user until the user command is inputted, e.g., a user may select 112a or 112b. In some examples, a user may set a “medium” threshold score which triggers an action 308, e.g., control circuitry may send a notification to the user in addition to modifying the content items presented on user device 102. Modifications to the content may comprise, but are not limited to, requesting at server 204 a display overlay on chosen content items that contributes to the cumulative moderation score exceeding the threshold score. For example, content items 104a and 104d contribute to the cumulative moderation score exceeding the threshold score and the user device 102 may send a request to server 204 for a display overlay on content items 104a and 104d. In response to the request, server 204 may send a manifest file comprising instructions to retrieve an overlay for inclusion on content items 104a and 104d and display the content items 104a and 104d with the overlay to the user device 102. In some examples, content items may be locally rendered. For example, a user may be using an XR device 202 with a user device 102 and in response to a content item with a high moderation score, the XR device 202 may place a display overlay over the content items. However, content items may be modified in any appropriate manner. If a “low” threshold is set, the control circuitry may replace content items which contribute to increasing the cumulative moderation score with moderation messages to stop the user from continuing to consume content. For example, control circuitry may request a different content item from the manifest file to replace the currently displayed content item. In another example, upcoming content items stored in the frame buffer of the user device 102 may be chosen to be not displayed to the user device dependent on their moderation score. In this case, control circuitry may extract metadata, e.g., textual and/or visual metadata, to determine the moderation score of each upcoming content item. If the cumulative moderation score of the upcoming content items exceeds the threshold score, a different content item may be requested from the manifest file to replace the upcoming content item. Additionally, or alternatively, a “low” threshold being exceeded by the cumulative moderation score on a media platform may result in the media platform to shut down and be restricted from use for a certain period. In some examples, the duration for which the media platform is to be shut down may be selected by the user at process 406 in which user preferences may be set by the user. For example, when control circuitry of the user device 102 transmits an API call to retrieve content data, the API call may be blocked by the server 204 in response to the threshold being exceeded. In this case, the application may not generate any content items for display. In some examples, the application may be terminated locally, e.g. by the user device 102. The shutdown of the application of a content provider may be executed in any appropriate manner. At 306, control circuitry may determine that the cumulative moderation score has not exceeded the threshold score and may continue to display sequential content items, process 302.

FIG. 4 shows a flowchart representing an illustrative process 400 for moderating content consumption, e.g., at one or more user device(s). While the example shown in FIG. 4 refers to the user of system 100, as shown in FIG. 1, it will be appreciated that the illustrative process shown in FIG. 2, may be implemented, in whole or in part, on system 100 and system 200, either alone or in combination with each other, and/or any other appropriately configured system architecture.

At 402, control circuitry, e.g., control circuitry of user device 102, receives a content item from a content provider “A” via a content database 702. At 404, control circuitry receives content items from a content provider “B” via a second content database 704. For example, the user may begin a scrolling session on an application configured to receive content from content provider “A” 702 and may subsequently begin a second scrolling session on a different application, platform, and/or user device configured to receive content from a different content provider “B” 704. In some cases, a single media platform may be configured to receive content items from multiple content providers, e.g., content provider “A” 702 and “B” 704.

At 406, control circuitry, e.g., control circuitry of server 204, executes a user command to set content moderation preferences. This may occur before consuming the content items or during consuming the content items. For example, a graphical user interface (GUI) may be executed on an application configured to receive content, e.g., from content database 702 or 704. The graphical user interface may comprise a slider control, allowing the user to adjust content moderation settings by moving an icon along a track. In other examples, the graphical user interface may be executed on a “Settings” application configured to receive content moderation preferences locally, e.g., at the user device 102, from a content provider. In other examples, the graphical user interface may be executed on an application executed by a third-party provider 904. In this case, the graphical user interface on an application executed by a third-party provider 904 may allow the user to select content preferences across multiple media platforms. For example, the graphical user interface executed by a third-party provider may allow the users to set preferences for chosen media platforms. For example, a user may choose to set a “high” threshold score for a social media platform and choose to set a “low” threshold score for a webpage of news outlets. In some examples, the graphical interface may provide advanced user content preferences which allow the user to specifically moderate content consumption. For example, the graphical user interface may comprise an input box to input keywords such that content items containing the keywords may be given a weighting which increases the moderation score. For example, a content item may be identified as containing the keyword using machine learning, such as using one or more neural networks. For example, a vector may be generated for each keyword and a plurality of other terms related to the keyword. Each vector is inputted into a trained neural network which generates an output based on the input vectors. For example, a user may input a keyword of ‘war’ and vectors may be generated that represents degrees of connection between ‘war’ and other terms, such as ‘weapons’, ‘bombs’, ‘nuclear meltdown’ or other terms. Content items containing the vectors may receive a high moderation score. In some examples, the graphical user interface may be generated on a XR device 202 wherein user content preferences may be set across multiple devices. The content moderation preferences may determine a threshold score 456 and subsequent actions 458 that will be executed when the threshold score is exceeded.

At 408, control circuitry, e.g., the control circuitry of the user device 102, generates content items for sequential display at the user device. For example, content items may be retrieved by the user device 102 from a content database 206. The retrieved content items may be displayed for user consumption on a media platform configured to receive content from content providers “A”, e.g., a first social media platform or from content provider “B”, e.g., a second social media platform.

At 410, control circuitry, e.g. control circuitry of user device 102, detects a user is scrolling. For example, a scrolling operation may be detected using optical character recognition (OCR), projection profile analysis, text line segmentation and/or page layout segmentation on a screen frame buffer (discussed below in further detail). However, a scrolling operation may be detected in any appropriate manner. In some examples, control circuitry may determine scrolling based on the displacement of pixels within a frame buffer. Scrolling may be detected at regular or irregular time interval, e.g., a user may be scrolling through content items on their mobile phone for an hour before taking a two-hour break and then continuing to scroll through content items again. In this case, the cumulative moderation score may be reset or adjusted based on the time interval between two scrolling sessions, e.g., if the interval between two scrolling sessions is longer than a day, the cumulative moderation score may reset or otherwise adjusted (e.g., reduced). In some examples, the moderation score may be adjusted based on the types of media platforms used from one scrolling session to another, e.g., a user may spend five hours on a news outlet platform, reading through news articles with large pieces of texts, and spend two hours scrolling on a social media platform. The moderation score for the news outlet application may be given a weighting that lowers the moderation score in comparison to the social media platform to account for a user reading the news articles in comparison to a user scrolling through photos on a social media platform. In some examples, control circuitry may adjust a threshold score automatically based on the user's scrolling sessions. For example, control circuitry may lower the threshold score if the threshold score is never reached during a scrolling session. In this case, the automatic lowering of the threshold score may be based on the user content preferences that were previously set at 406. For example, a user selecting an “aggressive” setting may indicate the user has a preference to a strict moderation of content and may reduce the threshold score if control circuitry detects that the threshold score has not been reached during a period of time in a scrolling session and/or a certain number of scrolling sessions. In some examples, control circuitry may monitor for when a user adjusts content preference after actions 458 have been undertaken. For example, the user may have previously set a content preference comprising a low threshold. When the user begins experiencing modifications to content, notifications regarding the threshold score has been exceeded and/or a shutdown of the media platform, the user may adjust content moderation preferences to comprise a lower threshold score and as such, control circuitry may stop automatic adjustments to the threshold score accordingly.

At 412, control circuitry, e.g., control circuitry of the user device, generates a set of content items. For example, the set of content items may be, but is not limited to, a recommended playlist, a user feed on a social media platform or webpage. The set of content items may be generated on different applications or on the same application and one or more sets of content items may be viewed concurrently by the user. For example, the set of content items may be defined by a content consumption period or a length of a scrolling session. Additionally or alternatively, the set of content items may be defined by content items that share a classification, such as news, e.g., based on metadata associated with the content items in the set.

At 414, control circuitry, e.g. control circuitry of user device 102, 202 and/or 204, determines a moderation score of a content item. The moderation score is determined by a signification of the content item 416 and/or a category of the content item 424. For example, the signification may be based on a semantic message of the content item, and the category of the content may be determined using a tag associated with each content item, wherein each tag indicates the genre of the content item, e.g., the content item may be news, comedy, currently trending, shared by a friend, etc. In FIG. 4, 414 comprises 416 and 424. 416 further comprises 418 to 422.

At 416, control circuitry, e.g. control circuitry of the user device 102, determines the signification of the content item. The signification of a content item may be based on the textual metadata associated with the content item, signification of a content item, visual characteristics of the content item and/or the sentiment analysis. Processes of 418, 420 and 422 may be used either alone or in combination with each other to determine the signification of the content item. Other alternative or additional actions are described below in more detail.

At 418, control circuitry, e.g., control circuitry of the user device 102 or the XR device 202, determines the moderation score based on the textual metadata of the content item. Textual metadata may be retrieved from a manifest file transmitted by a server 204. Textual metadata may be extracted via audio to text conversion for non-textual content items such as video programs or audio programs with a voice track. Textual metadata may be based on subtitles and/or closed captions. The context of the content item may be determined by the combination of textual metadata and visual characteristics within the content item. For example, control circuitry may extract a username, e.g., a name of a user authoring a content item and may relate the username to an image object within the content item. The underlying meaning of the username may be detected as relevant from a semantic standpoint to the rest of the content item, e.g., the username 604 of ‘Cthulhu’ may indicate the image object within the post to be an exaggerated comedic news article in comparison to a factual news article. In some examples, the user may have selected content moderation preferences such that keywords, selected by the user, may increase the weighting of the moderation score. For example, control circuitry of the user device 102, after receiving textual metadata of each content item, may score the content items containing the word ‘war’ higher than content items that do not contain the word.

At 420, control circuitry, e.g., control circuitry of the user device 102, determines the signification of a content item based on visual characteristics of a content item. For example, content item 104b comprising an image object of a city in ruins after an earthquake has struck may have negative connotations which may increase the moderation score of the content item. As previously discussed, the context of the content item may be determined by the combination of the visual characteristics being used with textual metadata which may adjust the moderation score. In some examples, the visual characteristic of a content post may include a profile picture of the user producing the content. For example, 602 is the profile picture of “Cthulhu” that produced the post message 606, and the identification of the profile picture may decrease the moderation score as the profile picture may reinforce the signification of the message being informal and humorous.

At 422, control circuitry, e.g., control circuitry of the user device 102, performs a sentiment analysis, e.g., of the content item. For example, control circuitry may execute a machine learning model such as a Large Language Model (LLM) to perform sentiment analysis on all of the metadata that has been extracted. For example, if the content item is a video, control circuitry may execute automatic content recognition (ACR) to extract an overall sentiment score 436 for the content item. In another example, control circuitry may compute a sentiment score 436 for each content element within a content item based on the sentiment analysis. In the example shown in FIG. 6, headline 610a, “Flooding in Innsmouth!”, may be weighted higher than sub-text 610b “Local cultists call for mayor Lovecraft resignation” due to their difference in font size. Similarly, the post message 606 “These people deserve the wrath of the elements! . . . ” may be weighted higher due to its position as an opening caption within the content item.

At 426, control circuitry, e.g., control circuitry of the user device 102, determines the user reaction to a content item. A user reaction may be determined from user data 428 being received at the user device 102. User data may include an action or interaction of a user, e.g., a verbal comment of the user and/or a textual comment posted to a social media feed. Determining the user reaction may be used to weight the moderation score of the content item 440, e.g., if the user reacts to content item 502a with a “like” or “thumbs-up”, the moderation score of the content item may be increased. In another example, data aggregated from the profile of the user may be used to determine the user reaction to the content item. For example, the user reaction may be based on actions recorded in the user profile, e.g., if the user previously has liked content related to cats, control circuitry may determine the user reaction to content item 502a as being a positive reaction.

At 430, control circuitry, e.g., control circuitry of the user device 102, determines parameters that weight the moderation score. In the example shown in FIG. 4, 430 comprises 432 to 436.

At 432, control circuitry, e.g., control circuitry of the user device 102, determines a display period as a parameter to weight the moderation score. For example, the period in which the content is present on the screen may be used to identify the display period of the content item. For example, if the content item is presented on the user device for a long period, the moderation score for the content item may have a higher weighting to the cumulative moderation score in comparison to the other content items displayed. In some examples, the weighting of the moderation score of a content item may be based on the duration of various content elements within the content item being viewed by the user. In the example shown in FIG. 6, a user may stop at the image 608 after scrolling past the caption 606 (“These people deserve the wrath of the elements!Mark my word . . . ”). In this case, the caption 606 may contribute lower to the moderation score of the content item in comparison to the contribution of the image object. In some examples, the user may be viewing more than one set of content items concurrently on a display screen. In this case, the weighting of the moderation score may be determined using a combination of parameters, e.g., the display period parameter and the focus value parameter.

At 434, control circuitry, e.g., control circuitry of the user device 202, determines a focus value as a parameter to weight the moderation score. For example, a focus value may be determined based on eye tracking. If the gaze of the user is focused on one content item e.g., content item 104a, longer than another content item, e.g. content item 104b, the moderation score for, e.g., content item 104a, may be higher than the moderation score for, e.g., content item 104b. Additionally or alternatively, where multiple content items are being shown by multiple media platforms (such as on a desktop), control circuitry may weight content items presented in a window or section of the screen, that has the focus of the user, higher than other content items presented in other portions of the screen. The focus value may be determined by a level of interaction the user is having with the portion of the screen in question such as scrolling interactions and/or the number of user inputs, e.g., the user ‘liking’ a social media post, or the number of playback operations executed in a video.

At 436, control circuitry, e.g., control circuitry of the user device 102, determines a sentiment score as a parameter to weight the moderation score. The sentiment score may be a result of sentiment analysis with a scoring range of −1 and 1, e.g., −1 may represent a very negative sentiment and 1 may represent a very positive sentiment. For examples where the content item is a video, control circuitry may use automatic content recognition (ACR) to validate the sentiment of the video, e.g., an episode of “Arrested Development”, the user is watching. For example, the ACR may assign a title or unique ID to the episode. Using the assigned ID of the episode, the ACR may compare the episode to associated metadata, e.g., guest stars, plotlines and/or the duration of the episode. The associated metadata may be assembled from the sentiment analysis performed previously and/or by the media platform that is executing the episode. Based on the associated metadata, an overall sentiment score for a segment or the entirety of the episode may be found. In some examples, control circuitry may compute a moderation score for a content element within a content item based on the result of the sentiment analysis and the way the content item and the particular content element is presented on the display of the user device 102. In some examples, aggregated sentiment analytics 438 may determine a sentiment score. For example, textual comments on content post 104a may include a high occurrence of negative language, e.g., “death”, “violence” and “murder”, and may subsequently determine the content post 104a to have a negative sentiment.

At 440, control circuitry, e.g., control circuitry of the user device 102, computes a weighted moderation score based on the parameters previously discussed.

At 442, control circuitry, e.g., control circuitry of the user device 102, computes a decay factor. The decay factor may be determined before the weighted moderation score is computed or after to update the moderation score. In the example shown in FIG. 4, 442 comprises 444 and 446.

At 444, control circuitry, e.g., control circuitry of the user device 102, determines the decay factor based on the display order of each content item in a set. For example, the moderation score for a content item may decrease by 10% every time a new content item is presented on the screen of the user.

At 446, control circuitry, e.g., control circuitry of the user device 102, determines the decay factor based on the duration for which each content item in a set is no longer displayed after being previously displayed. For example, the control circuitry may proceed to 452 and decrease the moderation score of a content item by a percentage, e.g., 10%, for a period, e.g., every 10 seconds, the content item is not displayed on the user device 102 after having been displayed.

At 448, control circuitry, e.g., control circuitry of the user device 102, receives metadata associated with upcoming content items. For example, upcoming content items may be in a frame buffer. Within the frame buffer, image analysis may be performed to extract metadata from the frame buffer. Control circuitry proceeds to 454 to determine the moderation score for the upcoming content items based on the metadata associated with the upcoming content items. The moderation score for the upcoming content items may be determined based on textual metadata, visual characteristics of the upcoming content items, a sentiment analysis and/or the category of the content item.

At 450, control circuitry, e.g., control circuitry of the user device 102, determines a number of instances in which a first content item in a set of sequentially displayed content items is displayed. For example, control circuitry may re-score a content item if the user scrolls back to its location after having scrolled past it. For example, control circuitry may double the moderation score of the content item if the user comes back to the content item once or may apply a different decay factor that increases or decreases with the number of times the user goes back to the content item. In some examples, control circuitry may record the content items it scores so that it does not re-score a content item it has already scored, thus avoiding wasting computing power. In some examples, control circuitry may compute and store visual hashes for identified content items and/or the result of a textual extraction to determine whether a content item needs to be re-scored. In some examples, a content item may be flagged when it is determined that the content item has been seen at multiple instances on multiple media platforms and its contribution may be adjusted adequately. The content items being seen at multiple instances may be content items that are of the repeats of one another and/or may be content items of a similar class, e.g., comedic posts or news articles about a political event may be of the same class of content. In another example, content items of the same category being displayed may be considered as instances, e.g., if two news articles of different content are displayed on a feed of the user, the two news articles may be considered two instances. If the user is viewing a content item at multiple instances that exceeds a threshold score, control circuitry may increase the moderation score of the content item to account for repetitiveness. In some examples, control circuitry may decrease the moderation score of a content item to account for the user getting used to the content item. The decision to update the moderation score by increasing or decreasing the moderation score may be based on the sentiment score for the content item. For example, repeats of content items with a negative message may have an increased moderation score while repeats of content items with a positive message may have a decreased moderation score. In the example shown in FIG. 4, 450 moves to 452 to update the moderation score based on the number of instances in which a first content item in a set of sequentially displayed content items is displayed.

At 456, control circuitry, e.g., control circuitry of the user device 102, compares the cumulative moderation score to the threshold score. For example, the threshold score may be dependent on the process 406 in which the moderation preferences set by the user may determine the threshold score. If the cumulative moderation score does not exceed the threshold score, the process 456 moves to 408, in which more content items are generated for sequential display, e.g., the user will continue being shown more content on the feed of the media platform in use. If the cumulative moderation score exceeds the threshold score, the process 456 moves to 458 in which an action will occur in response to the threshold score being exceeded.

At 458, control circuitry, e.g., control circuitry of the user device 102 causes an action to occur in response to the cumulative moderation score exceeding the threshold score. Process 458 comprises 460 to 468. Each action may be dependent on 406 in which the user sets the moderation preferences as previously discussed.

At 460, control circuitry, e.g., control circuitry of the user device 102, generates an alert. In some examples, the alert may be, but is not limited to, a notification, a sound alert, e.g., an alarm may sound signaling that the cumulative moderation score has exceeded the threshold score and/or a vibration alert. In some examples, control circuitry may transmit an alert to a third-party device, e.g., a parent or guardian may receive an alert on another device that is linked to user device 102 to inform the guardian of the threshold being exceeded on user device 102.

At 462, control circuitry, e.g., control circuitry of the user device 102, modifies the content items that are currently displayed on the user device and/or upcoming content items that are not currently displayed on the user device. For example, a content item may be modified by blurring the text and/or visual aspects of the content item or replacing the content item with another content item of a lower moderation score. Modifications to the content items may be done by requesting the server to update the manifest file with additional content to replace a content item. In some examples, modifications to the content items may be a request to server 204 for a display overlay on a content item to blur or mask the content item. In some examples, the content items may be modified by local rendering at the user device 102, 202. For upcoming content causing the cumulative moderation score to exceed the threshold score, the time at which the upcoming content items is displayed may be delayed. In this case, an API call to server 204 may be delayed which may cause the display of content items at a different time, e.g., content items may be displayed at a later time of day if the cumulative moderation score during a first scrolling session is high. Other suitable methods to modify and/or mask the content items may be appropriate.

At 464, control circuitry, e.g., control circuitry of the user device 102, notifies the content provider “A” and/or content provider “B”. For example, when a cumulative moderation score exceeds a threshold score within a media platform configured to receive content from content provider “A” and/or “B”, the response may be to trigger an API call for action to be taken within the media platform. For example, upon receiving such an API call, a media platform may elect to alter its recommendations to serve different content to the user. In another example, the media platform may use an API call to alter the user profile based on the content displayed during the scrolling session, to limit the amount of similar content in subsequent scrolling sessions.

At 468, control circuitry, e.g., control circuitry of the user device 102, removes the content item from being either currently displayed or being displayed in the future. For example, content items generated for display on a media platform may be removed from display.

FIG. 5 shows example media content items being analyzed to determine moderation scores. While the example shown in FIG. 5 may be displayed on system 100, as shown in FIG. 1, it will be appreciated that the media content shown in FIG. 5, may be displayed, in whole or in part, on system 100 and system 200, either alone or in combination with each other, and/or any other appropriately configured system architecture.

In the example shown in FIG. 5, two content items 502a and 504a are segmented into two independent content items. For example, control circuitry, e.g., control circuitry of the user device 102, may use image analysis tools such as saliency identification and/or border detection to refine the boundaries of each content item. After control circuitry segments the two content items 502a and 504a on the display of the user device 102, control circuitry may extract textual information 502c to determine the signification of content item 502a. For example, the caption 502c of the content item 502a may determine the content item 502a to be a positive content post about cats. The extraction of textual metadata of the content item 502a may be used alone or in combination with visual characteristics of the content item, e.g., the image 502b. For example, control circuitry may determine from the text 502c and the image 502b that content item 502a is a positive post about kittens being rescued. Additionally, or alternatively, a semantic analysis may be performed on the content item 502a to determine the signification of the content item 502a. For example, the profile picture 502d of the author of the post may be used in the semantic analysis to confirm the post as being a positive, factual message. In another example, aggregated sentiment analytics may be retrieved of the content item 502a to compute a sentiment score for the content item 502a. For example, the content item 502a may be reposted by users with positive comments and as such, may be identified as having a positive message in comparison to content item 504a which may have negative comments and fewer ‘Likes’ and, as such, may be identified as having a negative message.

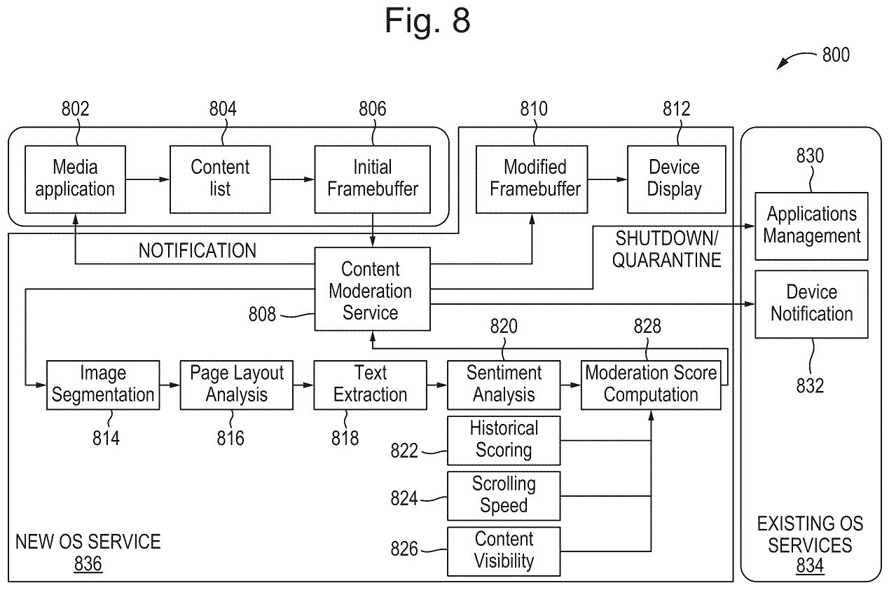

FIG. 6 shows example media content having a moderation score and has been discussed above in the context of FIG. 4 and FIG. 8.

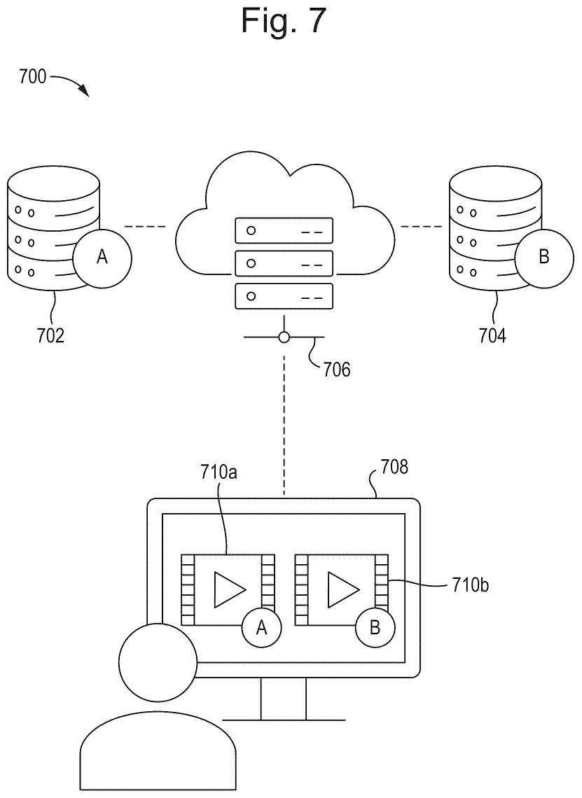

FIG. 7 shows an overview of an example system 700 for moderating content consumption across different content providers. While the example shown in FIG. 7 refers to the user of system 100, as shown in FIG. 1, it will be appreciated that the illustrative process shown in FIG. 7, may be implemented, in whole or in part, on system 100 and system 200, either alone or in combination with each other, and/or any other appropriately configured system architecture.

In the example shown in FIG. 7, the user device is a computer 708 and the user is consuming two content items, 710a and 710b, that are transmitted by two different content databases, 702 and 704 respectively. The content items are transmitted to the user device 708 via a cloud server 700. In this example, the content item 710a may be a social media post and content item 710b may be supplemental content. In another example, the content items 710a and 710b may be viewed concurrently by the user, e.g., news article 710a and video 710b may be viewed at the same time by the user on two different portions of the screen. However, in another example, content item 710a and content item 710b may be viewed at different time periods, e.g., content item 710a may be viewed in the morning and content item 710b may be viewed at night. In some examples, content item 710a may be viewed on an application configured to receive content from the content database 702 and content item 710b may be displayed on an application configured to receive content from content database 704. In this case, the user may be viewing the content items 710a and 710b concurrently across the different applications or may first view content item 710a the application and then proceed to view 710b in a different application. In this case, the cumulative moderation score may be adjusted based on the applications used from one scrolling session to another. For example, if a user uses two social media platforms, control circuitry may not alter the cumulative moderation score or the decay functions from one session to the next. However, in some examples, if a user starts a scrolling session on a news webpage after a scrolling session on a social media platform, control circuitry may decrease the weighting parameter related to the display period 432 for the social media platform as the user may scroll through content faster on a social media platform than through news articles.

FIG. 8 is an illustrative block diagram showing example system 800, e.g., the system architecture, for in-frame content moderation.

In the example shown in FIG. 8, the system 800 comprises a new content moderation system 836 built into an existing operating system (OS) service 834, e.g., iOS, to formulate the system architecture of system 100. The existing operating system service 834 comprises 802 to 806, and 830 to 832.

In the example shown in FIG. 8, a media platform 802 is executed by an OS service 834, e.g., a computer running a social media platform on a webpage. The media platform 802 causes a content list 804 to be generated for display, e.g., on the feed page of the user. The set of content items generated for display may be stored in an initial framebuffer 806 before being rendered for display. In some examples, content items presented by the media platform may be protected by digital rights management (DRM), e.g., a media platform that offers protected videos, and as such, the framebuffer may include areas that are not accessible to the OS or another media platform with elevated privileges. In this case, control circuitry may rely on surrounding DRM-free data to determine the type of content being displayed to the user. In some examples, control circuitry may adjust the periodicity of sampling of the framebuffer of the user device to extract content items. For example, control circuitry may not resample the framebuffer until a user action indicative of a scrolling operation, e.g., swiping on a touchscreen display, is detected. In some examples, control circuitry may determine a sampling rate of the framebuffer based on the size of the content item being extracted and the scrolling speed, e.g., the amplitude of the swipe. In some examples, the content moderation service 808 analyzes content items stored in the initial framebuffer 806.

At 808, control circuitry, e.g., control circuitry of the user device 102, executes the content moderation service, a feature in the new OS service. In some examples, the content moderation service may include a configuration interface which may allow the user to include or exclude certain media platforms 802 from content moderation. A configuration interface, within the third-party moderation service 808, may list one or multiple media platforms 802 installed on the user device 102 and/or 202 that are recognized as candidates for content moderation. In some examples, the content moderation service may include a machine learning model pre-trained at extracting content information from a specific set of media platforms. A user may use the configuration interface to select which pre-recognized media platforms are to be moderated or may indicate an application not pre-recognized to be moderated. In this case, if an unrecognized application is selected for content moderation, a new machine learning model may be used and the user may be prompted to help train the machine learning model by indicating content boundaries within the unrecognized application. For example, if a recently installed media platform, e.g., consisting of a set of videos on a webpage, is chosen for moderation, the user may input content moderation boundaries, e.g., the machine learning model may be trained to increase the moderation score of animal videos. In another example, the content moderation configuration interface may include privacy settings allowing the user to share information regarding the scrolling session of the user with multiple media platforms 802. For instance, a user may indicate that they agree for the exceeding of a content moderation threshold to be shared with other platforms, whereas the user may indicate that they disagree with their content consumption itself to be shared with other platforms. For example, the exceeding of a threshold score may be shared with a mental health focused Artificial Intelligence (AI) assistant that may help the user with content consumption habits.

At 814, control circuitry, e.g., control circuitry of the user device 102, the set of content items stored in the initial framebuffer may undergo image segmentation. For example, the control circuitry may split a news article into individual content items. For example, the news article may consist of 10 paragraphs and 3 images and control circuitry may generate 13 individual content items or may split the content item into 13 individual content elements, thereby segmenting the images from the news article. In some examples, control circuitry may identify an image as an advertisement or supplemental content unrelated to the news article and may score the content item a lower moderation score than the other content items contained within the news article. Additionally or alternatively, images within a content item may also be segmented into different content elements. For example, image 608 of content item 600 may be segmented such that the houses within image 608 have a low contribution to the moderation score whilst the flood water has a high contribution to the moderation score. In some examples, the user may train a machine learning model, as previously discussed, to increase the moderation score for images containing a specific content element, e.g., floods.

At 816, control circuitry, e.g., control circuitry of the user device 102, executes a page layout analysis. A page layout analysis may consist of, but is not limited to, segmenting paragraphs within a body of text, e.g., a caption on a post and/or segmenting structural features of an applications, e.g., a webpage may be segmented into headers, footers, content, navigation. Control circuitry may determine a contribution to the moderation score of each of the segmented elements.

At 818, control circuitry, e.g., control circuitry of the user device 102, executes text extraction. As previously discussed, control circuitry may extract the signification of a content item based on the textual metadata collected.

At 820, control circuitry, e.g., control circuitry of the user device 102, performs a sentiment analysis, as previously discussed. Additionally, or alternatively, control circuitry may detect bias or polarization in content. For example, control circuitry may perform a bias analysis on classes of content. The bias score may be represented by a vector representing the various biases for the various “classes of content”. For example, a class of content may be political. The vector may be computed using a machine learning model that would vectorize classes of content and then compute a bias associated with the classes of content. The determination that a bias threshold has been exceeded may be performed by comparing each individual bias component to individual bias threshold or using a vector norm or magnitude formula. For example, control circuitry may determine a user has previously been scrolling through content items indicative of a certain political orientation only and in response to the bias score exceeding a threshold, the user may receive a notification of the potential exposure to bias political content. For example, in response to the bias score exceeding a threshold, links to alternate political views may be sent as a notification and/or alterations to the upcoming content items may be made in the frame buffer 810, to display to the content alternative political views.

At 822, control circuitry, e.g., control circuitry of the user device 102, determines historical scoring. For example, a content item may be previously assigned a moderation score, e.g., within a scrolling session or in a previous scrolling session. Control circuitry accounts for a moderation score already being assigned to a content item and may adjust the moderation score for the content item accordingly. For example, if a user scrolls back to a content item after having previously viewed it, as previously discussed, control circuitry may increase the moderation score. Control circuitry may record the moderation scores of content items in previous scrolling sessions as to not re-score a content item it has already scored, thus avoiding wasting computing power.

At 824, control circuitry, e.g., control circuitry of the user device 102, determines a scrolling speed. The determination of the scrolling speed is of a similar manner as previously discussed above.

At 826, control circuitry, e.g., control circuitry of the user device 102, determines content visibility. Control circuitry may determine the legibility of a visual content item, e.g., an image based on the number of pixels there are in the image. For example, there may be a threshold of the number of pixels a visual content item may have and when the threshold is exceeded, the visual content item may be identified as legible. If the number of pixels is below the threshold, the visual content item may be deemed illegible and in response, the moderation score may be adjusted, e.g., the moderation score of the visual content item may be lowered. For textual content items, e.g., a news article, legibility may be based on understandability of the user. For example, gaze tracking may record a user's gaze consecutively re-reading a textual social media post which may be indicative of confusion and/or a lack of understanding. In this case, the moderation score may be lowered based on the lack of legibility of the social media post. In another example, the legibility of the textual content item may be determined by, but not limited to, a natural language processor, optical character recognition and/or a machine learning model.

At 828, control circuitry, e.g., control circuitry of the user device 102, determines the moderation score. As previously discussed, the moderation score may be based on processes performed at or by blocks 814, 816, 818, 820, 822, 824, and/or 826. Each block may provide a contribution and/or weighting to the moderation score of a content item. In some examples, control circuitry may determine the derivative of the cumulative moderation score and compare the derivative of the cumulative moderation score to a threshold score. For example, the derivative of the moderation score may be determined by dividing the cumulative moderation score by a duration of a scrolling session. In some examples, multiple derivatives may be determined. In the example shown in system 100, the derivation of the cumulative moderation score would be the gradient of the line 106.

At 830, control circuitry, e.g., control circuitry of the user device 102, executes a shutdown of an application in response to cumulative score, or the derivative of the cumulative score, exceeding a threshold score. For example, the threshold being exceeded by the cumulative moderation score, or the derivative of the moderation score, may trigger control circuitry to terminate the media platform.

At 832, control circuitry, e.g., control circuitry of the user device 102, executes a device notification in response to the cumulative score exceeding a threshold score. The notification, as previously discussed, may be the examples of process 460. Control circuitry may transmit the notification to the media platform.

At 810, control circuitry, e.g., control circuitry of the user device 102, may modify content items stored in the framebuffer, in response to the threshold score being exceeded a cumulative moderation score. In the framebuffer, control circuitry may modify the pixels of the content items stored in the framebuffer, e.g., by reducing the resolution of the content item and/or by adding a filter, e.g., blurring filter, over the pixels of the content item. Control circuitry may also render the content items locally in the framebuffer. 810 moves to process 812, in which the modified content items will be generated for display.

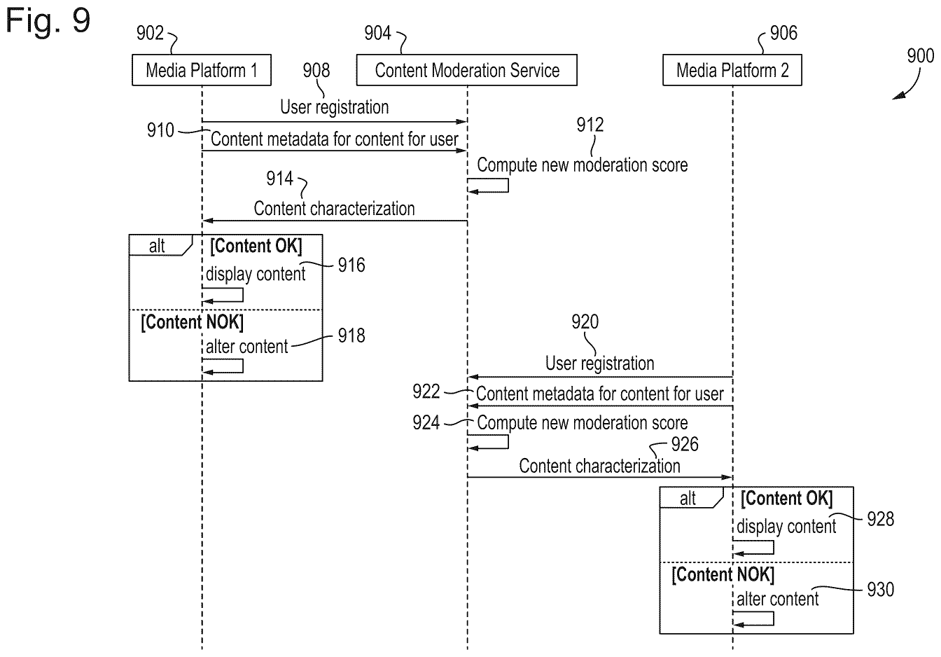

FIG. 9 is an illustrative block diagram showing example processes performed by system 900, e.g., a content moderation service communicating with two media platforms, configured to moderate content items across multiple media platforms. In the example system 900, 902 represents a media platform, e.g., a media platform, in which the user has a first scrolling session on. 904 represents a second media platform in which the user has a second scrolling session on. 904 represents a third-party service provider. The advantage of a centralized content moderation service external to a media platform as opposed to integrated to a media platform is that the contribution of all the registered media platforms can be accounted for in the computation of a cumulative moderation score. For example, a user may begin a scrolling session on media platform 902 and proceed to media platform 906. The content moderation system may be able to account for the contribution to the moderation score of a first session while the user is scrolling through a second session regardless of the source of the content presented during the first and the second session. For example, a user may start scrolling on a laptop, move to a smartphone and continue on a television. With a centralized moderation system, all interactions with content across multiple devices and/or media platforms may be considered when computing a moderation score. In this case, user hopping from device to device to avoid moderation, e.g., a child attempting to circumvent content moderation setup as a parental control, would be defeated.

At 908, control circuitry, e.g., control circuitry of the user device 102 and/or 202, transmits a user registration of media platform 902 to a third-party content moderation service 904. In this case, the user may register media platforms 902 and 906 on the content moderation service 904, e.g., the user may transmit a username and password, corresponding to media platform 902, to the content moderation service 904 to allow the content moderation service 904 to monitor content on the media platform 902. In some embodiments, control circuitry, e.g., control circuitry of the content moderation service server, may transmit an API call for a request of user registration data from a media platform 902. User registration data may comprise any data shared by the user during which the user registers to the media platform. User registration data may be, but is not limited to, location, user activity, user ID, first and surname name of the user, contact information of the user and/or data of birth of the user. In some examples, there may privacy settings the user is required to consent to for the user's data to be shared with the content moderation service. In some examples, the content moderation service may store the registration information of the user, e.g., the age of the user, and may adjust the weightings of the moderation score of categories accordingly, e.g., content items with a content rating higher than the age of the user may have a moderation score with a higher weighting. In some examples, the content moderation service may determine the duration of a scrolling session based on the time between the user logging into the media platform 902 and the user terminating the media platform 902.

At 910, control circuitry, e.g., control circuitry of content moderation service server, transmits an API call, to the media platform 902, to request content metadata of the content items yet to be displayed. In some examples, the content metadata may undergo 814, 816, 818, 820, 822, 824, 826 and/or 828 of FIG. 8 and proceed to 912. In another example, the content moderation service may receive content metadata from the media platform 902 after the content items are generated for display to the user. For example, the media platform 902 may select a content item for the user, e.g., displaying a photo on a user feed and subsequently, the media platform may transmit metadata related to that content item to the content moderation service for validation. The content moderation service 904 may compute a cumulative moderation score of the content item based on the signification of the content item, as previously discussed. For example, a media platform 902 may select a media post that includes a textual message and an image to present to a user. The media platform 902 and/or 904 may send to the content moderation service a link to the image and the textual representation of the message. In some examples, the media platform 902 and/or 904 may use a JSON structure to communicate with the content moderation service as illustrated below:

```
{
  “post”: {
    “text”: {
      “content”: “Excited to share this beautiful sunset I captured last
      night!”,
      “font_size”: “16px”
    },
    “image”: {
      “url”: “https://example.com/images/sunset.jpg”,
      “display_size”: “1024x768”,
    }
}
```

At 910, in which the content moderation service receives metadata of the user post, the content moderation service may analyze the image and the textual message and compute a moderation score. In some examples, the content may not yet be presented to the user and as such, the content moderation service may limit its computation of the moderation score based solely on the metadata the media platform sends. For example, in the JSON structure above, the content moderation service may weigh the moderation score of the media post based on the sentiment analysis results for both the image and the post text and based on the size of the text and image on screen. The content metadata may include additional metadata comprising, but not limited to, user interactions, e.g., ‘liking’ a social media post, scrolling speed, scrolling amplitude and/or reactions of the user, e.g., using data from an eye tracker. In some examples, moderation score 912 may be computed based on the additional metadata of the content item, allowing for a more accurate scoring. At 914, control circuitry, e.g., control circuitry of content moderation service server, transmits the content characterization to the media platform 902. For example, the content moderation service 904 may return a response to the media platform 902 based on the computed cumulative moderation score. For example, if the cumulative moderation score does not exceed a moderation threshold score, the response may be an all OK, 916, to publish an upcoming content item for user consumption.

The content characterization may comprise a moderation score that may be updating a previous moderation score or may be scoring new content. The cumulative moderation score of the complete set of content items is compared to a threshold score. The media platform 902 may determine that the cumulative moderation score is not exceeded, and proceed to 916 in which subsequent content items are generated for display to the user. When the threshold score is exceeded by the cumulative moderation score, process 914 moves to 918, in which the content is altered, as previously discussed.

At 906, control circuitry, e.g., control circuitry of user device 102, detects a second scrolling session occurring at a second media platform. Processes are carried out in a similar manner to 902. However, in some examples, a cumulative moderation score may be based on content items from both media platforms 902 and 906.

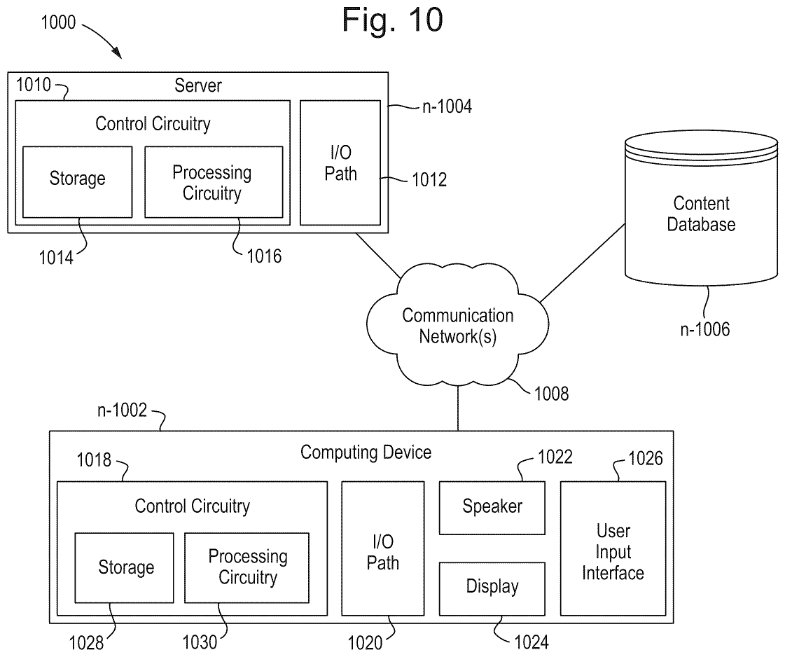

FIG. 10 is an illustrative block diagram showing example system 1000, e.g., a non-transitory computer-readable medium, configured to moderate content items, e.g., content items 104a, 104b, 104c, and 104d. Although FIG. 10 shows system 1000 as including a number and configuration of individual components, in some examples, any number of the components of system 1000 may be combined and/or integrated as one device, e.g., as user device 102. System 1000 includes computing device n-1002 (denoting any appropriate number of computing devices, such as user device 102 and/or XR device 202), server n-1004 (denoting any appropriate number of servers, such as server 204), and one or more content databases n-1006 (denoting any appropriate number of content databases, such as content database 206), each of which is communicatively coupled to communication network 1008, which may be the Internet or any other suitable network or group of networks, such as network 208. In some examples, system 1000 excludes server n-1004, and functionality that would otherwise be implemented by server n-1004 is instead implemented by other components of system 1000, such as computing device n-1002. For example, computing device n-1002 may implement some or all of the functionality of server n-1004, allowing computing device n-1002 to communicate directly with content database n-1006. In still other examples, server n-1004 works in conjunction with computing device n-1002 to implement certain functionality described herein in a distributed or cooperative manner.

Server n-1004 includes control circuitry 1010 and input/output (hereinafter “I/O”) path 1012, and control circuitry 1010 includes storage 1014 and processing circuitry 1016. Computing device n-1002, which may be an HMD, a personal computer, a laptop computer, a tablet computer, a smartphone, a smart television, or any other type of computing device, includes control circuitry 1018, I/O path 1020, speaker 1022, display 1024, and user input interface 1026. Control circuitry 1018 includes storage 1028 and processing circuitry 1020. Control circuitry 1010 and/or 1018 may be based on any suitable processing circuitry such as processing circuitry 1016 and/or 1030. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some examples, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 1014, 1028, and/or storages of other components of system 1000 (e.g., storages of content database 1006, and/or the like) may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 1014, 1028, and/or storages of other components of system 1000 may be used to store various types of content, metadata, and or other types of data. Non-volatile memory may also be used (e.g., to launch a boot-up routine and other instructions). Cloud-based storage may be used to supplement storages 1014, 1028 or instead of storages 1014, 1028. In some examples, control circuitry 1010 and/or 1018 executes instructions for an application stored in memory (e.g., storage 1014 and/or 1028). Specifically, control circuitry 1010 and/or 1018 may be instructed by the application to perform the functions discussed herein. In some implementations, any action performed by control circuitry 1010 and/or 1018 may be based on instructions received from the application. For example, the application may be implemented as software or a set of executable instructions that may be stored in storage 1014 and/or 1028 and executed by control circuitry 1010 and/or 1018. In some examples, the application may be a client/server application where only a client application resides on computing device n-1002, and a server application resides on server n-1004.

The application may be implemented using any suitable architecture. For example, it may be a stand-alone application wholly implemented on computing device n-1002. In such an approach, instructions for the application are stored locally (e.g., in storage 1028), and data for use by the application is downloaded on a periodic basis (e.g., from an out-of-band feed, from an Internet resource, or using another suitable approach). Control circuitry 1018 may retrieve instructions for the application from storage 1028 and process the instructions to perform the functionality described herein. Based on the processed instructions, control circuitry 1018 may determine what action to perform when input is received from user input interface 1026.

In client/server-based examples, control circuitry 1018 may include communication circuitry suitable for communicating with an application server (e.g., server n-1004) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 1008). In another example of a client/server based application, control circuitry 1018 runs a web browser that interprets web pages provided by a remote server (e.g., server n-1004). For example, the remote server may store the instructions for the application in a storage device. The remote server may process the stored instructions using circuitry (e.g., control circuitry 1010) and/or generate displays. Computing device n-1002 may receive the displays generated by the remote server and may display the content of the displays locally via display 1024. This way, the processing of the instructions is performed remotely (e.g., by server n-1004) while the resulting displays, such as the display windows described elsewhere herein, are provided locally on computing device n-1002. Computing device n-1002 may receive inputs from the user via input interface 1026 and transmit those inputs to the remote server for processing and generating the corresponding displays.

A computing device n-1002 may send instructions, e.g., to initiate an XR experience and allow a user to view and interact with another user in an XR environment, to control circuitry 1010 and/or 1018 using user input interface 1026.

User input interface 1026 may be any suitable user interface, such as a remote control, trackball, keypad, keyboard, touchscreen, touchpad, stylus input, joystick, voice recognition interface, gaming controller, or other user input interfaces. User input interface 1026 may be integrated with or combined with display 1024, which may be a monitor, a television, a liquid crystal display (LCD), an electronic ink display, or any other equipment suitable for displaying visual images.

Server n-1004 and computing device n-1002 may transmit and receive content and data via I/O path 1012 and 1020, respectively. For instance, I/O path 1012, and/or I/O path 1020 may include a communication port(s) configured to transmit and/or receive (for instance to and/or from content database n-1006), via communication network 1008, content item identifiers, content metadata, natural language queries, and/or other data. Control circuitry 1010 and/or 1018 may be used to send and receive commands, requests, and other suitable data using I/O paths 1012 and/or 1020.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

1. A method for moderating content consumption, the method comprising:
receiving, at a user device, content items for sequential display, wherein the content items are distributed from one or more content providers;
determining, using control circuitry associated with the user device, a moderation score for
each content item in a set of sequentially displayed content items, wherein the moderation score for each content item in the set is based on a signification of the content item;
determining, using control circuitry associated with the user device, that a cumulative moderation score for the set of sequentially displayed content items is greater than a threshold moderation score; and
causing, using control circuitry associated with the user device, an action affecting the continued consumption of the sequentially displayed content items.

2. The method according to claim 1, the method comprising determining the signification of the content item based on at least one of:
textual metadata associated with the content item;
a visual characteristic of the content item; and
sentiment analysis.

3. The method according to claim 2, the method comprising:
determining a display period for each content item in the set of the sequentially displayed content items;
determining a focus value for each content item in the set of the sequentially displayed content items based on the textual metadata and the visual characteristic;
determining a sentiment score based on the sentiment analysis; and
weighting the moderation score for at least one of the content items in the set of the sequentially displayed content items based on at least one of the display period, the focus value, or the sentiment score.

4. The method according to claim 1, the method comprising:
determining a decay factor for at least one content item in the set of the sequentially displayed content items, wherein the decay factor is based on at least one of:
a display order of each content item in the set of the sequentially displayed content items; or
a duration for which each content item in the set of the sequentially displayed content items is no longer displayed after being displayed; and
updating the moderation score for the least one content item based on the decay factor.

5. The method according to claim 1, wherein the sequentially displayed media content items are generated for display using a scrolling operation, the method comprising:
detecting the scrolling operation being performed at the user device;
generating the sequentially displayed content items for display at the user device; and
performing a segmentation operation on the sequentially displayed content items to define the set of sequentially displayed media content items in response to the detected scrolling operation.

6. The method according to claim 1, wherein the sequentially displayed media content is distributed for display from multiple content providers.

7. The method according to claim 1, the method comprising:
determining a user reaction to content; and
weighting the moderation score based on the user reaction.

8. The method according to claim 1, wherein the method comprises:
receiving metadata associated with an upcoming media content item in the sequentially displayed content items;
determining a moderation score associated with the upcoming media content item;
determining that the cumulative moderation score for the set of sequentially displayed content items will be greater than the threshold moderation score based on the moderation score associated with the upcoming media content item; and
causing the upcoming media content item to not be displayed.

9. The method according to claim 1, the method comprising:
determining a number of instances that a first content item in the set of the sequentially displayed content items is displayed; and
updating the moderation score for the first content based on the number instances of display of the first content item.

10. The method according to claim 1, wherein the moderation score is determined using at least one of:
a user device on which the content items are generated for display;
an XR device viewing a user device on which the content items are generated for display; or
a third-party service operating in cooperation with a first-party content provider distributing content to a user device on which the content items are generated for display.

11. A system for moderating content consumption, the system comprising: control circuitry configured to:
receive, at a user device, content items for sequential display, wherein the content items are distributed from one or more content providers;
determine a moderation score for each content item in a set of sequentially displayed content items, wherein the moderation score for each content item in the set is based on a signification of the content item;
determine that a cumulative moderation score for the set of sequentially displayed content items is greater than a threshold moderation score; and
cause an action affecting the continued consumption of the sequentially displayed content items.

12. The system of claim 11, wherein the control circuitry is further configured to determine the signification of the content item based on at least one of:
textual metadata associated with the content item;
a visual characteristic of the content item; and
sentiment analysis.

13. The system of claim 12, wherein the control circuitry is further configured to: determine a display period for each content item in the set of the sequentially displayed content items;
determine a focus value for each content item in the set of the sequentially displayed content items based on the textual metadata and the visual characteristic;
determine a sentiment score based on the sentiment analysis; and
weight the moderation score for at least one of the content items in the set of the sequentially displayed content items based on at least one of the display period, the focus value, or the sentiment score.

14. The system of any of claim 11, wherein the control circuitry is further configured to:
determine a decay factor for at least one content item in the set of the sequentially displayed content items, wherein the decay factor is based on at least one of:
a display order of each content item in the set of the sequentially displayed content items; or
a duration for which each content item in the set of the sequentially displayed content items is no longer displayed after being displayed; and
update the moderation score for the least one content item based on the decay factor.

15. The system of claim 11, wherein the control circuitry is further configured to:
generate sequentially displayed media content items for display using a scrolling operation;
detect the scrolling operation being performed at the user device;
generate the sequentially displayed content items for display at the user device; and
perform a segmentation operation on the sequentially displayed content items to define the set of sequentially displayed media content items in response to the detected scrolling operation.

16. The system of claim 11, wherein the control circuitry is further configured to distribute sequentially displayed media content for display from multiple content providers.

17. The system of claim 11, wherein the control circuitry is further configured to:
determine a user reaction to content; and
weight the moderation score based on the user reaction.

18. The system of claim 11, wherein the control circuitry is further configured to:
receive metadata associated with an upcoming media content item in the sequentially displayed content items;
determine a moderation score associated with the upcoming media content item;
determine that the cumulative moderation score for the set of sequentially displayed content items will be greater than the threshold moderation score based on the moderation score associated with the upcoming media content item; and
cause the upcoming media content item to not be displayed.

19. The system of claim 11, wherein control circuitry is further configured to:
determine a number of instances that a first content item in the set of the sequentially displayed content items is displayed; and
update the moderation score for the first content based on the number instances of display of the first content item.

20. The system of claim 11, wherein the control circuitry is configured to determine the moderation score using at least one of:
a user device on which the content items are generated for display;
an XR device viewing a user device on which the content items are generated for display; or
a third-party service operating in cooperation with a first-party content provider distributing content to a user device on which the content items are generated for display.

21-50. (canceled)
